(19) United States
(12) Patent Application Publication
(10) Pub. No.: US 2020/0226536 A1
(43) Pub. Date: Jul. 16, 2020

(54) CONSTRAINED CONCURRENT RESOURCE ALLOCATOR

(71) Applicants: Kshitiz Uttam, Bangalore (IN); Narasimha Kamath, Bangalore (IN); Koustuv Chatterjee, San Ramon, CA (US)

(72) Inventors: Kshitiz Uttam, Bangalore (IN); Narasimha Kamath, Bangalore (IN); Koustuv Chatterjee, San Ramon, CA (US)

(21) Appl. No.: 16/245,719

(22) Filed: Jan. 11, 2019

(51) Int. Cl. G06Q 10/08; G06Q 30/02

(52) U.S. Cl. CPC G06Q 10/087; G06Q 10/083; G06Q 30/0202

(57) ABSTRACT

Systems and techniques for constrained concurrent resource allocator are described herein. A first demand request may be received including a first demand value for a first resource in a supply chain node hierarchy from a first demand node of the supply chain node hierarchy. The supply chain node hierarchy may be traversed to identify a capacity node of the supply chain node hierarchy between the first demand node and a supply node of the supply chain node hierarchy. A first resource temporary capacity reservation may be created at the capacity node. An available supply of the first resource may be identified in the supply chain node hierarchy. The first resource temporary capacity reservation may be replaced with a first resource supply capacity reservation equal to a supply of the first resource processed by the capacity node using the available supply.

### TECHNICAL FIELD

Embodiments described herein generally relate to supply chain resource allocation and, in some embodiments, more specifically to constrained concurrent resource allocation in a supply chain node hierarchy.

### BACKGROUND

A supply chain may include a variety of supply points, activity points, storage and capacity. An item of material may flow through the supply points and activity points that exist between a supply and a designated destination for the supply. A supply chain management system may manage the flow of materials through the supply chain. The supply chain may include constraints that may limit the flow of supplies that may flow through a point in the supply chain. If two demands share a constraint capacity, it may be over subscribed leading to a failure in the supply chain.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a flow diagram of an example of a supply chain node hierarchy for a constrained concurrent resource allocator, according to an embodiment.

FIG. 2 is a block diagram of an example of an environment and a system for a constrained concurrent resource allocator, according to an embodiment.

FIG. 3 illustrates a flow diagram of an example of a process for a constrained concurrent resource allocator, according to an embodiment.

FIG. 4 illustrates a flow diagram of an example of a method for a constrained concurrent resource allocator, according to an embodiment.

FIG. 5 is a block diagram illustrating an example of a machine upon which one or more embodiments may be implemented.

### DETAILED DESCRIPTION

A supply chain is a representation of real world network that includes procurement, manufacturing and distribution. The supply chain may describe the flow of materials through a distribution or assembly network. There may be several segments of the supply chain that demand supply from the supply chain. When a demand request is made, a supply may be located in the supply chain and may flow through the supply chain to the demand. The supply chain may include constraints such as storage capacity, transportation capacity, resource capacity, etc. The constraints may impact the ability of the supply chain to fulfill demands. For example, sugar and salt may flow through a supply chain transportation object with a capacity of 100 material units. If a sugar demand for 90 units and a salt demand for 50 units are received, the total demand may exceed the transportation capacity. Thus, some portion of the salt and sugar will not be able to be transported.

Traditional supply chain management systems may allow both the sugar demand and the salt demand to process because both demands are within the capacity of the transportation capacity node. This may lead to unfulfilled demands or delayed demand fulfillment. This may cause a ripple effect in the supply chain as the backup impacts demand processing further up and down the supply chain. To address the inability of traditional supply chain management systems to manage shared constraints in a supply chain, the systems and techniques discussed herein generate a supply chain node hierarchy and generate capacity reservations at capacity nodes to prevent oversubscription.

The supply chain may be represented as a graph network including a variety of nodes as a supply chain node hierarchy. This representation breaks down complex real-world systems into an assembly of four different node types and respective edges. Node types may include material nodes, capacity nodes, activity nodes, storage nodes, etc. A material node is a logical representation of a product or component at a location. Thus, a material node may be referred to as an item location. A capacity node is a logical representation of a resource. For example, a capacity node may represent assembly line capacity, shipping capacity, labor capacity, etc. An activity node is a logical representation of an operation in a supply chain. Operations may include a shipment operation (e.g., where a material travels from one location to another), an assembly operation (e.g., where one or more components are combined to make an intermediate product or finished good), etc. A storage node represents a real-world warehouse where one or more components, intermediate goods, or finished goods are stored as inventory.

The nodes in the supply chain node hierarchy may be connected by a variety of edges including production edges, consumption edges, capacity edges, and storage edges. A production edge is a directed edge from an activity node to a material node representing a flow of material. In an example, the production edge may go from a material node to an activity node (e.g., materials flow to activity node to get assembled). In another example, the production edge may be bi-directional, so that assembled sub-assemblies (e.g., created at an activity node) may be sent to a material node to be used as materials for a next line in assembly. A consumption edge is a directed edge from a material node to an activity node representing a flow of material. A capacity edge is an edge from a capacity node to an activity node. A storage edge is an edge from a storage node to a material node.

Traditional supply chain planning techniques may process demands order by order (e.g., pick one demand at a time and traverse up the graph network to supply the demand). Even if the demands have same priority, internally there may be a tie breaker to send the demands to the resource allocator in sequential order. This may prevent oversubscription of capacity and storage. However, processing demands in sequential order may degrade performance of the system when processing large storage capacities and large demand volume. Thus, traditional supply chain planning techniques may not be scalable to complex supply chain networks.

The systems and techniques discussed herein provide concurrent demand processing by identification of supply segments and planning them concurrently in a fully interconnected network. Processing demands by segment may be beneficial by reducing processing operations (e.g., by processing the identified segment rather than the entire network, etc.) when the capacity/storage is large where a large chunk of demands get processed in parallel. As the capacity reduces (e.g., booked for the demands already planned, etc.), the demands are competing (e.g., salt demands vs. sugar demands, etc.), reservations for the demands on the segment may be sequential because a demand might have to wait for a reservation to be removed to plan a similar priority demand. The demand that reaches the capacity node first reserves first (e.g., similar to flight reservation—may get cancelled later, in which case the reservation is released) and books the capacity. This provides a performance boost as each supply segment may be run in parallel reducing the solve time (e.g., resulting in reduced processor usage, memory usage, power usage, etc.). These features allow each business to have a set window to run and obtain supply chain processing plans to aid decision making.

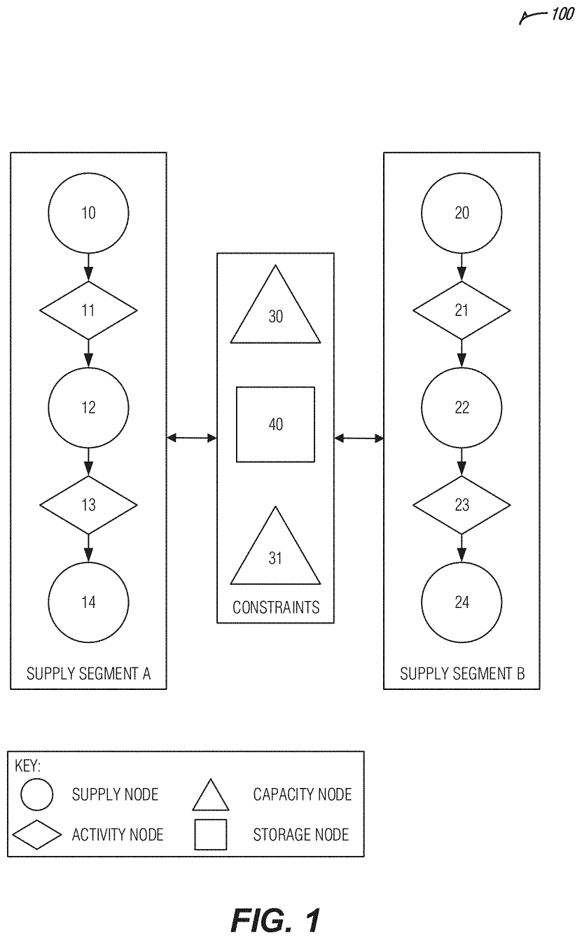

FIG. 1 illustrates a flow diagram of an example of a supply chain node hierarchy 100 for a constrained concurrent resource allocator, according to an embodiment. The supply chain node hierarchy 100 may include a variety of supply nodes and activity nodes in a first supply segment (e.g., supply segment A, etc.) and a second supply segment (e.g., supply segment B, etc.). The supply chain node hierarchy 100 may include constraints including capacity nodes and storage nodes. The constraints may be resource limitations (e.g., storage capacity, transportation capacity, production capacity, etc.) that may impact supply flow of the first supply segment if used by the second supply segment and vice versa.

A distribution network where two items, say sugar and salt, are sourced from a supplier in Delhi and sold at two local retailers in Bangalore may demonstrate an example of a constrained supply chain. The salt and sugar items are not shipped directly to the retailers in Bangalore from Delhi. Rather, the salt and sugar are shipped from a supplier, to the supplier in Delhi, to a warehouse in Bangalore, and are eventually shipped to the retailers. The supplier in Delhi that supplies both salt and sugar may be split into two logical material nodes (e.g., supply node 10 in supply segment A and the supply node 20 in supply segment B, etc.). The warehouse in Bangalore may also be split into two logical material nodes (e.g., supply node 12 in supply segment A and supply node 22 in supply segment B, etc.). One material node may be part of the salt supply chain and the other may be part of the sugar supply chain.

The activity nodes may represent shipment between supply nodes. For example, activity node 11 in supply segment A may represent shipment of salt from the Delhi supplier (e.g., supply node 10 in supply segment A) to the Bangalore warehouse (e.g., supply node 12 in supply segment A) and activity node 21 in supply segment B may represent shipment of sugar from the Delhi supplier (e.g., supply node 20 in supply segment B) to the Bangalore warehouse (e.g., supply node 22 in supply segment B). Activity node 13 in supply segment A may represent shipment of salt from the Bangalore warehouse (e.g., supply node 12 in supply segment A) to a retailer in Bangalore (e.g., supply node 14 in supply segment A) and activity node 23 in supply segment B may represent shipment of sugar from the Bangalore warehouse (e.g., supply node 22 in supply segment B) to a retailer in Bangalore (e.g., supply node 24 in supply segment B).

In an example, the shipment from the Delhi supplier to the Bangalore warehouse may be facilitated via trucks. The same trucks may be used to ship both salt and sugar. There may be a limited number of trucks available for shipping products at a given activity node. This means that both shipment operations (e.g., activity node 11 in supply segment A and activity node 21 in supply segment B) share a common trucking capacity resource. The Bangalore warehouse may have a limited number of trucks to deliver salt and sugar to the retailers. Capacity nodes are included in the supply chain node hierarchy 100 to represent constraints. For example, capacity node 30 may represent a trucking capacity associated with activity node 11 in supply segment A and activity node 21 in supply segment B. Capacity node 31 may represent a trucking capacity associated with activity node 13 in supply segment A and activity node 23 in supply segment B.

Storage capacity may be another constraint. For example, the Bangalore warehouse (e.g., supply node 12 in supply segment A and supply node 22 in supply segment B) may have a limited storage capacity of 100 units of salt, sugar, or a mixture of salt and sugar. A storage node 40 may represent the limited capacity of the Bangalore ware house supply nodes (e.g., supply node 12 in supply segment A and supply node 22 in supply segment B). The shared constraints on salt and sugar result in a dependency between the salt and sugar supplies. For example, the Bangalore retailer supply node 14 in supply segment A may request 100 units of salt and the retailer supply node 24 in supply segment 24 may request 100 units of sugar for a week. However, the trucking capacity of capacity node 30 may be limited to 100 units. Thus, either the salt or the sugar may be supplied, but not both. It may be possible to resolve the constraint by assigning priorities to the demands. However, this approach would allow the salt or the sugar to be supplied depending on which demand has a higher priority. If both demands have the same priority, the supply chain may break because the capacity node may be oversubscribed if both demands are allowed to process or if both demands are prevented from proceeding. In reality, there may be millions of demands and sufficient capacity to fulfill a substantial portion of the demands in full. Thus, synchronization of demands and solving them on an individual basis may not be necessary for a majority of demands.

The techniques and systems discussed herein provide a solution to fulfilling demands along multiple supply segments by processing the demands along the supply chain segments in parallel. For example, there may be four demands on supply segment A between the Delhi supplier (e.g., supply node 10 in supply segment A) and the Bangalore retailer (e.g., supply node 14 in supply segment A). Demands may be on material nodes (e.g., material nodes 12, 14, 22, 24). Demands may be, a conversion of a material (e.g., in case of manufacturing) or movement of materials (e.g., in case of distribution). A material node (e.g., material node 12, etc.) may have multiple corresponding demands (e.g., from a first customer, second customer, etc.) and at different points in time (e.g., a first time period, second time period, etc.).

The demands corresponding to supply node 11 in supply segment A and to supply node 21 in supply segment B may be processed in parallel as they both have a priority of 1. The same may be true of the demands corresponding to supply node 12 in supply segment A and to supply node 22 in supply segment B, supply node 13 in supply segment A and to supply node 23 in supply segment B, and supply node 14 in supply segment A and to supply node 24 in supply segment B as they have equal priorities respectively. To process the demands in parallel, a supply request associated with a demand is propagated upstream while the supply associated with the request is propagated downstream. Temporary resource reservations may be made at the intervening nodes while the demand of one supply segment is being processed. Upon processing completion, the temporary reservations may be made permanent (e.g., until the demand has been met, etc.).

Demands on other supply segments may periodically (or continuously) process until its supply may be met. For example, the demand processor for a first demand from the first supply segment may have placed a temporary reservation for 100 units of salt on a capacity node. A second demand from a second supply segment may be processed and find that there is no capacity at the capacity node because there is a temporary reservation by the first demand. The demand processor for the first demand may not have been able to find a supply of 100 units of salt in the supply chain node hierarchy 100. The temporary reservation may be removed from the capacity node. The demand processor for the second demand may again process the demand and make a temporary reservation at the capacity node and may attempt to locate a supply of sugar. If so, the supply and capacity will be reserved.

While the supply chain node hierarchy 100 shows a limited number of supply segments, nodes, and constraints, it may be understood that a fully developed supply chain node hierarchy may include millions of supply segments, nodes, and constraints. The limited supply chain node hierarchy 100 provided in FIG. 1 is provided in a simple form to preserve space and in the interest of clarity.

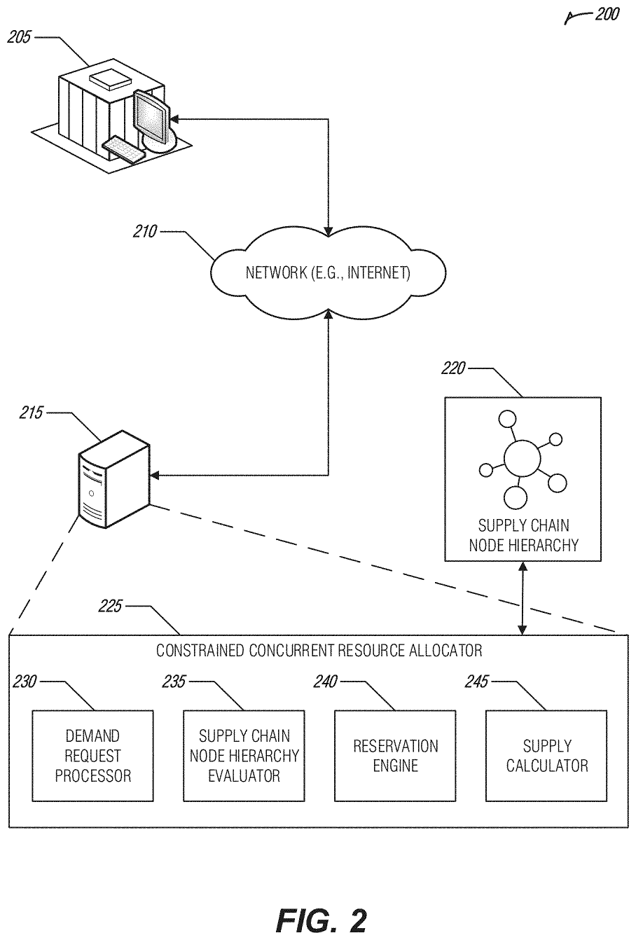

FIG. 2 is a block diagram of an example of an environment 200 and a system 225 for a constrained concurrent resource allocator, according to an embodiment. The environment 200 may include a demand node 205 (e.g., a location associated with a demand, etc.), a network 210 (e.g., wired network, wireless network, internet, etc.), a resource allocation server 215 (e.g., a standalone server, a server cluster, a cloud computing network, a virtualized computing platform, a system on a chip, a virtual machine, etc.), a supply chain node hierarchy 220 (e.g., a graph network representing the supply chain including the demand node 205, the supply chain node hierarchy 100 as described in FIG. 1, etc.), and the system 225. In an example, the system 225 may be a constrained concurrent resource allocator. The system 225 may include a variety of components including a demand request processor 230, a supply chain node hierarchy evaluator 235, a reservation engine 240, and a supply calculator 245.

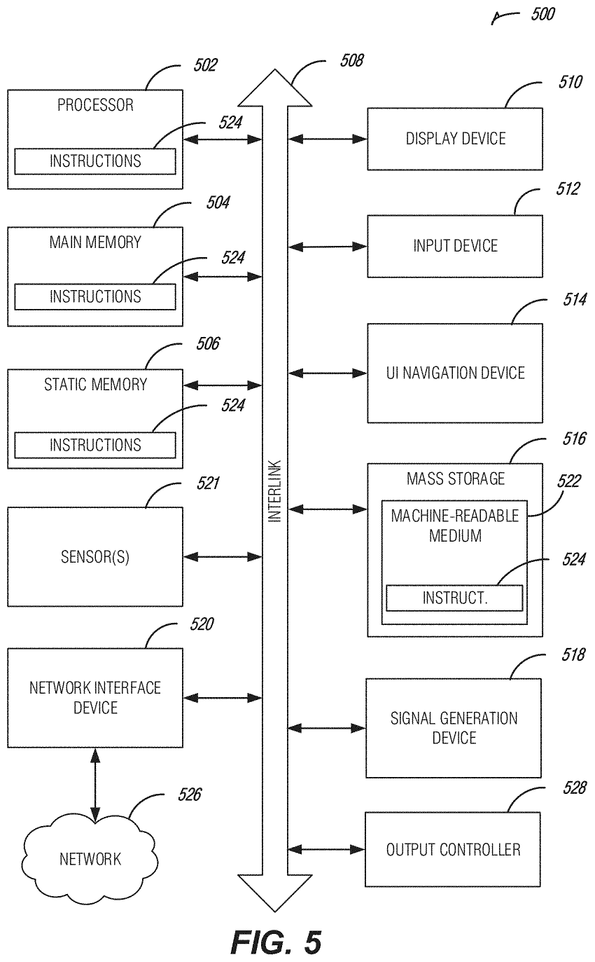

The demand request processor 230, the supply chain node hierarchy evaluator 235, reservation engine 240, and supply calculator 245 may comprise one or more processors (e.g., hardware processor 502 described in FIG. 5, etc.) that execute software instructions, such as those used to define a software or computer program, stored in a computer-readable storage medium such as a memory device (e.g., a main memory 504 and a static memory 506 as described in FIG. 5, a Flash memory, random access memory (RAM), or any other type of volatile or non-volatile memory that stores instructions), or a storage device (e.g., a disk drive, or an optical drive). Alternatively, the demand request processor 230, the supply chain node hierarchy evaluator 235, reservation engine 240, and supply calculator 245 may comprise dedicated hardware, such as one or more integrated circuits, one or more Application Specific Integrated Circuits (ASICs), one or more Application Specific Special Processors (ASSPs), one or more Field Programmable Gate Arrays (FPGAs), or any combination of the foregoing examples of dedicated hardware, for performing the techniques described in this disclosure. The demand request processor 230, the supply chain node hierarchy evaluator 235, reservation engine 240, and supply calculator 245 may be implemented on a single computing device (e.g., physical server, virtual server, client computer, etc.) and their respective functions may be distributed across multiple computing devices (e.g., a collection of networked servers, cloud computing instance, etc.).

The demand node 205 may represent an entity (e.g., user of an item, person, organization, facility, warehouse, retailer, manufacturer, etc.) that has a demand for a resource (e.g., item, service, etc.) that may be supplied from the supply node hierarchy 220. The supply chain hierarchy 220 may include a variety of supply segments, nodes, and constraints such as those described in FIG. 1. The demand node 205 may be a node with an edge along one or more supply segments and may share an edge with one or more nodes in the one or more supply segments. The demand node 205 may transmit a first request for a supply of a first resource to the resource allocation server 215 via the network 210. The resource allocation server 215 may receive the request and the request may be processed by the system 225.

The demand request processor 230 may receive the first demand request that includes a first demand value for the first resource in the supply chain node hierarchy 220 from the demand node 205 (e.g., a first demand node) of the supply chain hierarchy 220. For example, a retailer in Bangalore may request 100 units of salt from the supply chain hierarchy 220. The demand request processor 230 may receive a second demand request including a second demand value for a second resource from a second demand node. For example, a retailer in Bangalore may request 100 units of sugar from the supply chain node hierarchy 220. In an example, the first demand request is received from a first supply segment and the second demand request is received from a second supply segment. The supply segment may be identified based on the item to be supplied and the configuration of a graph network representing the supply chain. For example, the supply chain network graph may be traversed starting at the demand node corresponding to the demand to the first supply node that has a corresponding supply of the item. Thus, rather than processing the entire supply chain graph network, the nearest segment containing a supply of the item may be processed. This may reduce computing resource usage for calculating supply for the demand.

The supply chain node hierarchy evaluator 235 may traverse the supply chain node hierarchy 220 to identify a capacity node of the supply chain node hierarchy 220 between the first demand node (e.g., demand node 105) and a supply node of the supply chain node hierarchy 220. The supply node may include an indication of a supply of the first resource. For example, supply chain node hierarchy evaluator 235 may traverse the edges and nodes of the supply chain node hierarchy 220 to propagate the request up the supply chain until a supply of 100 units of salt is located. Capacity nodes between the supply node and the demand node 205 may be identified by the supply chain node hierarchy evaluator 235. In an example, the capacity node may be one of a transportation capacity node or a storage capacity node. In an example, the capacity node represents a shared constraint among the first supply segment and the second supply segment. For example, 100 units of a resource may be able to flow through an activity node and both the salt supply and the sugar supply may flow through the activity node. In an example, the first supply segment may include nodes of the supply chain node hierarchy 220 between the first demand node and the supply node not including the capacity node and the second supply segment may include nodes of the supply chain node hierarchy 220 between the second demand node and the supply node not including the capacity node.

The reservation engine 240 may create a first resource temporary capacity reservation at the capacity node. In an example, the demand request may include a time period for fulfillment of the request. For example, the capacity node may be associated with a shipping activity node and may have a capacity limit of 150 units for the time period specified in the demand. The reservation engine 240 may create a reservation of 100 units at the capacity node indicating that 100 of the 150 total capacity units may be used in fulfilling the request. Temporary reservations may be made for other capacity nodes between the supply node and the demand node. For example, warehouse storage capacity may be reserved if a capacity node between the supply node able to supply salt and a demand node requesting salt indicates there is a limitation. In another example, a supply from more than one supply node may be needed to meet the first demand value and temporary reservations may be created at capacity nodes encountered as the supply chain node hierarchy evaluator 235 progresses up the hierarchy.

The supply chain node hierarchy evaluator 235 may traverse the supply chain node hierarchy 220 to attempt to locate a supply of the second resource to fulfill the second demand request. For example, the supply chain node hierarchy evaluator 235 may move up the hierarchy from the demand node to locate the requested 100 units of sugar for the Bangalore retailer. The supply chain node hierarchy evaluator 235 may identify that there is insufficient capacity at the capacity node for the second resource based on the first resource temporary capacity reservation.

The supply calculator 245 may identify an available supply of the first resource available in the supply chain hierarchy 220. In an example, as the supply chain node hierarchy 220 is traversed by the supply chain node hierarchy evaluator 235, the supply calculator 245 may keep a running total of a quantity of the resource is available at each supply node. When the supply calculator 245 determines that the available supply matches the first demand value, the supply calculator 245 may signal the supply chain node hierarchy evaluator 235 to cease traversing the supply chain node hierarchy 220.

The reservation engine 240 may replace the first resource temporary capacity reservation with a first resource supply capacity reservation equal to a supply of the first resource processed by the capacity node using the available supply. For example, if a supply node is able to provide 50 units of salt, a reservation may be created at a shipping capacity node for a shipping activity node sharing an edge with the supply node.

The size of the capacity reservation may become smaller as the supply from supply nodes higher up the supply chain node hierarchy are accessed as less units of product may be flowing down the supply chain. For example, a nearest first supply node may have 20 units of salt available, a next nearest second supply node may have 20 units of salt available, and the farthest third supply node may have 60 units of salt available. A total of 100 units of salt (e.g., 20 from the first supply node, 20 from the second supply node, and 60 from the third supply node) may flow between the first supply node and the demand node so a reservation of 100 units may be created at a capacity node between the demand node and the first supply node. A total of 80 units of salt (e.g., 20 from the second supply node and 60 from the third supply node) may flow between the second supply node and the first supply node so a reservation of 80 units may be created at a demand node between the first supply node and the second supply node. A total of 60 units of salt (e.g., 60 from the third supply nodes) may flow between the third supply node and the second supply node so a reservation of 60 units may be created at a capacity node between the third supply node and the second supply node.

In an example, it may be determined that the supply node does not include a supply of the resource and the first resource supply capacity reservation may be discarded. For example, there may not be enough salt to fulfill the demand request so the reservation at the capacity node may be discarded so that other requests may reserve the capacity. In another example, it may be determined that the demand request has been fulfilled and the first resource supply capacity may be discarded. For example, all of the requested salt may have passed through (e.g., has been processed by, etc.) the capacity node and the capacity may be restored by discarding the reservation.

The supply node hierarchy evaluator 235 may repoll the capacity node upon expiration of a timeout value to determine the current capacity of the capacity node. Temporary capacity reservations may be discarded so the capacity node may be required to see if there is sufficient capacity. The repolling may be completed at a set interval or may be part of a loop that repolls the capacity node as part of a set of processing operations. The reservation engine 140 may create a second resource temporary capacity reservation at the capacity node when capacity becomes available. The supply calculator 245 may calculate the supply of the second resource similar to how the supply of the first resource was calculated as described above. The reservation engine 240 may replace the second resource temporary capacity reservation with a second resource supply capacity reservation equal to a supply of the second resource processed by (e.g., has been processed by, etc.) the capacity node using the available supply of the second resource. For example, transportation capacity for 100 units of sugar for the retailer in Bangalore may be reserved if a supply is located.

The components of the system 225 may use a variety of algorithms in processing the demands. For example, the following algorithm may be used to propagate a demand request upstream while propagating supplies of resources downstream:

```
PostRequest(MaterialNode node, float request) {
  var originalRequest = request;
  float localSuuply = GetLocalSupply(node);
  request = request - localSupply;
  ReserveLocalSupply(node, localSupply);
  var activity = GetProducingActivity(node);
  if (activity != null) {
    var response = PostRequest(activity, request);
    request = request - response;
    if (request == 0) break;
    }
    var response = originalRequest - request;
    return response;
    }
    PostRequest(ActivityNode node, float request) {
      var capacityNode = GetCapacityNode(node);
      var availCapacity = GetAvailableCapacity(capacityNode);
      request = Min(availCapacity, request);
      var materialNode = GetConsumedMaterialNode(node);
      var response = PostRequest(materialNode, request);
      ReserveCapacity(capacityNode, response);
      return response;
    }
```

The algorithm includes two invariants: (1) in PostRequest (MaterialNode, request), request>=response, and (2) in PostRequest (ActivityNode, request). Therefore, capacity may always be reserved at ReserveCapacity( ) because (availableCapacity>=request). However, if two supply segment demand requests are being processed concurrently, invariant 2 is no longer valid because the available capacity may be have changed. For example, while the first demand request is being processed for the first resource (e.g., the supply chain node hierarchy 220 is being traversed, etc.) a second demand request may form a second demand node on anther supply segment may be traversing the supply chain node hierarchy 220 lower in the hierarchy. This may have changed the assumptions (e.g., capacity availability, supply availability, etc.) made by the processor processing the first demand request. For example, both demand processes may have reserved 100 units of a shipping capacity node that has a total capacity of 100.

However, because the first demand processer and the second demand processor are working on different supply segment, the PostRequest( ) functions do not need to be thread safe. However, GetAvailableCapacity( ) and ReserveCapacity( ) functions take-in CapacityNode as a parameter which may be shared among multiple supply segments resulting in a need for synchronization. For example, the following synchronization algorithm may be used:

```
GetAvailableCapacity(CapacityNode node) {
  var response = 0;
  lock (node) {
    response = node.AvailableCapacity;
  }
  return response;
}
ReserveCapacity(CapacityNode node, float request) {
  var response = 0;
  lock (node) {
    response = Min(request, node.AvailableCapacity);
    node.AvailableCapacity −= response;
  }
  return response;
}
```

The example algorithm provides synchronization of shared node. Another algorithm may be used to keep the nodes updated. For example, the following algorithm may prevent broken invariants in PostRequest (ActivityNode, request):

```
PostRequest(ActivityNode node, float request) {
  var capacityNode = GetCapacityNode(node);
  var availCapacity = GetAvailableCapacity(capacityNode);
  request = Min(availCapacity, request);
  var materialNode = GetConsumedMaterialNode(node);
  var response = request;
    do {
        request = response;
        var response = PostRequest(materialNode, request);
          }while(response!=ReserveCapacity(capacityNode, response))
          return response;
    }
```

The while loop continues to retry the request in it is equal to the response. Thus, the invariant remains updated as the demand request is processed. The techniques and systems discussed herein provide the supply chain management system with the ability to process high volume resource demand requests in an efficient manner by resolving competing request processes in parallel. This reduces errors in supply chain processing and provides scalability to the supply chain management system by

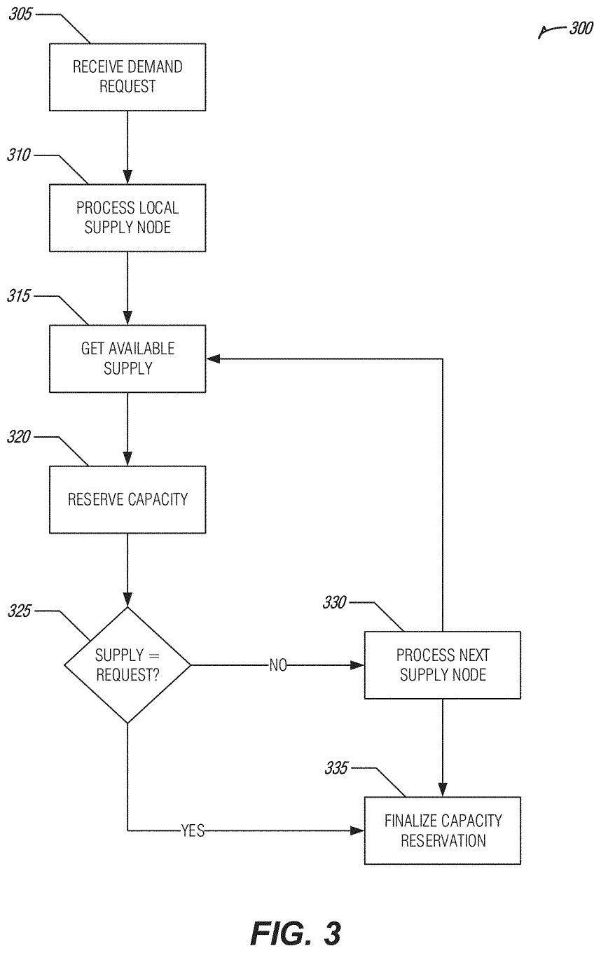

FIG. 3 illustrates a flow diagram of an example of a process 300 for a constrained concurrent resource allocator, according to an embodiment. The process 300 may provide features as described in FIGS. 1 and 2.

At operation 305, a demand request may be received (e.g., by the demand request processor 230 as described in FIG. 2, etc.). For example, a request for 100 units of sugar may be received from a demand node associated with a retailer in Bangalore.

At operation 310, a local supply node may be processed by evaluating traversing (e.g., by the supply chain node hierarchy evaluator 235 as described in FIG. 2, etc.) a supply chain node hierarchy (e.g., supply chain node hierarchy 100 as described in FIG. 1, supply chain node hierarchy 220 as described in FIG. 2, etc.) to find the first supply node (e.g., least edges between the demand node and the supply node, etc.). For example, the first supply node may be associated with a warehouse in Bangalore. At operation 315, the available supply may be determined for the first supply node (e.g., by the supply calculator 245 as described in FIG. 2, etc.). For example, it may be determined that 50 units of sugar may be available at the first supply node.

At operation 320, a capacity node may be identified between the demand node and the supply node and a temporary capacity reservation may be created at the capacity node (e.g., by the reservation engine 240 as described in FIG. 2, etc.). For example, a reservation of 100 units of capacity may be reserved at the capacity node associated with a shipping capacity for the Bangalore warehouse.

At decision 325, it may be determined (e.g., by the supply calculator 245 as described in FIG. 2, etc.) whether the supply is equal to the request. For example, the supply of sugar at the supply node is 50 units of sugar and the request is for 100 units of sugar, so the supply is not equal to the request. If it is determined at operation 325 that the supply does not equal the request, a second supply node up the supply chain node hierarchy may be processed at operation 330. Processing then continues at operation 315 and the supply available at the second supply node is determined. For example, it may be determined that the second supply node associated with a supplier in Delhi has 50 units of sugar available. At operation 320, capacity may be reserved at a second capacity node between the first supply node and the next supply node. For example, a temporary reservation of 50 units of sugar may be made at the second capacity node because only 50 units of sugar will need to be shipped between the supplier in Delhi and the warehouse in Bangalore.

If it is determined at decision 325 that the supply is equal to the demand, processing continues to operation 335 and the capacity reservations are finalized. For example, 50 units of sugar will be shipping from the supplier in Delhi to the warehouse in Bangalore so a reservation of 50 capacity units is reserved at the second capacity node and 100 units of sugar will be shipping from the Bangalore warehouse to the Bangalore retailer so a reservation of 100 capacity units is reserved at the first capacity node.

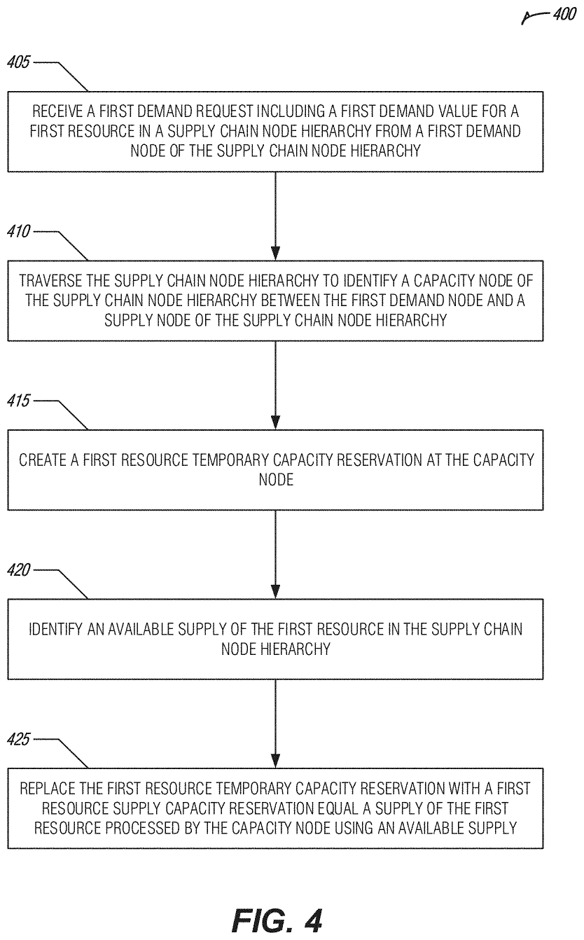

FIG. 4 illustrates a flow diagram of an example of a method 400 for a constrained concurrent resource allocator, according to an embodiment. The method 400 may provide features as described in FIGS. 1-3.

A first demand request may be received (e.g., by the demand request processor 230 as described in FIG. 2, etc.) including a first demand value for a first resource in a supply chain node hierarchy from a first demand node of the supply chain node hierarchy (e.g., the supply chain node hierarchy 100 as described in FIG. 1, the supply chain node hierarchy 220 as described in FIG. 2, etc.) (e.g., at operation 405). In an example, a second demand request may be received including a second demand value for a second resource from a second demand node. In an example, the first demand request may be received from a first supply segment and the second demand request may be received from a second supply segment.

The supply chain node hierarchy may be traversed (e.g., by the supply chain node hierarchy evaluator 235 as described in FIG. 2) to identify a capacity node of the supply chain node hierarchy between the first demand node and a supply node of the supply chain node hierarchy (e.g., at operation 410). The supply node may include an indication of a supply of the first resource. In an example, the capacity node may represent a shared constraint among the first supply segment and the second supply segment. In an example, the first supply segment may include nodes of the supply chain node hierarchy between the first demand node and the supply node not including the capacity node and the second supply segment may include nodes of the supply chain node hierarchy between the second demand node and the supply node not including the capacity node. In an example, the capacity node may be one of a transportation capacity node and a storage capacity node.

A first resource temporary capacity reservation may be created (e.g., by the reservation engine 240 as described in FIG. 2, etc.) at the capacity node (e.g., at operation 415). In an example, it may be determined that there is insufficient capacity at the capacity node for the second resource based on the first resource temporary capacity reservation. In an example, the capacity node may be repolled upon expiration of a timeout value to determine the current capacity of the capacity node. In an example, a second resource temporary capacity reservation at the capacity node.

An available supply of the first resource may be identified (e.g., by the supply chain node hierarchy evaluator 235 and supply calculator 245 as described in FIG. 2, etc.) in the supply chain node hierarchy (e.g., at operation 420). In an example, an available supply of the second resource may be identified at the supply node.

The first resource temporary capacity reservation may be replaced (e.g., by the reservation engine 240 as described in FIG. 2, etc.) with a first resource supply capacity reservation equal to a supply of the first resource processed by the capacity node using the available supply (e.g., at operation 425). In an example, the second resource temporary capacity reservation may be replaced with a second resource supply capacity reservation equal to a supply of the second resource processed by the capacity node using the available supply of the second resource. In an example, it may be determined that the supply node does not include a supply of the resource and the first resource supply capacity reservation may be discarded. In another example, it may be determined that the demand request has been fulfilled and the first resource supply capacity reservation may be discarded.

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensors. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. In an example, machine readable media may exclude transitory propagating signals (e.g., non-transitory machine-readable media). Specific examples of non-transitory machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, 3^{rd} Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### Additional Notes

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for a constrained concurrent resource allocator, the system comprising:
at least one processor; and
a memory including instructions that, when executed by the at least one processor, cause the at least one processor to perform operations to:
receive a first demand request including a first demand value for a first resource in a supply chain node hierarchy from a first demand node of the supply chain node hierarchy;
traverse the supply chain node hierarchy to identify a capacity node of the supply chain node hierarchy between the first demand node and a supply node of the supply chain node hierarchy, wherein the supply node includes an indication of a supply of the first resource;
create a first resource temporary capacity reservation at the capacity node;
identify an available supply of the first resource in the supply chain node hierarchy; and
replace the first resource temporary capacity reservation with a first resource supply capacity reservation equal to a supply of the first resource processed by the capacity node using the available supply.

2. The system of claim 1, further comprising instructions that, when executed by the at least one processor, cause the at least one processor to perform operations to:
receive a second demand request including a second demand value for a second resource from a second demand node;
identify that there is insufficient capacity at the capacity node for the second resource based on the first resource temporary capacity reservation;
repoll the capacity node upon expiration of a timeout value to determine the current capacity of the capacity node;
create a second resource temporary capacity reservation at the capacity node;
identify an available supply of the second resource at the supply node; and
replace the second resource temporary capacity reservation with a second resource supply capacity reservation equal to a supply of the second resource processed by the capacity node using the available supply of the second resource.

3. The system of claim 2, wherein the first demand request is received from a first supply segment and the second demand request is received from a second supply segment.

4. The system of claim 3, wherein the capacity node represents a shared constraint among the first supply segment and the second supply segment.

5. The system of claim 4, wherein the first supply segment includes nodes of the supply chain node hierarchy between the first demand node and the supply node not including the capacity node and the second supply segment includes nodes of the supply chain node hierarchy between the second demand node and the supply node not including the capacity node.

6. The system of claim 1, wherein the capacity node is one of a transportation capacity node and a storage capacity node.

7. The system of claim 1, further comprising instructions that, when executed by the at least one processor, cause the at least one processor to perform operations to:
determine that the supply node does not include a supply of the resource; and
discard the first resource supply capacity reservation.

8. The system of claim 1, further comprising instructions that, when executed by the at least one processor, cause the at least one processor to perform operations to:
determine that the demand request has been fulfilled; and
discard the first resource supply capacity reservation.

9. At least one non-transitory machine-readable medium including instructions for a constrained concurrent resource allocator that, when executed by at least one processor, cause the at least one processor to perform operations to:
receive a first demand request including a first demand value for a first resource in a supply chain node hierarchy from a first demand node of the supply chain node hierarchy;
traverse the supply chain node hierarchy to identify a capacity node of the supply chain node hierarchy between the first demand node and a supply node of the supply chain node hierarchy, wherein the supply node includes an indication of a supply of the first resource;
create a first resource temporary capacity reservation at the capacity node;
identify an available supply of the first resource in the supply chain node hierarchy; and
replace the first resource temporary capacity reservation with a first resource supply capacity reservation equal to a supply of the first resource processed by the capacity node using the available supply.

10. The at least one machine-readable medium of claim 9, further comprising instructions that, when executed by the at least one processor, cause the at least one processor to perform operations to:
receive a second demand request including a second demand value for a second resource from a second demand node;
identify that there is insufficient capacity at the capacity node for the second resource based on the first resource temporary capacity reservation;
repoll the capacity node upon expiration of a timeout value to determine the current capacity of the capacity node;
create a second resource temporary capacity reservation at the capacity node;
identify an available supply of the second resource at the supply node; and
replace the second resource temporary capacity reservation with a second resource supply capacity reservation equal to a supply of the second resource processed by the capacity node using the available supply of the second resource.

11. The at least one machine-readable medium of claim 10, wherein the first demand request is received from a first supply segment and the second demand request is received from a second supply segment.

12. The at least one machine-readable medium of claim 11, wherein the capacity node represents a shared constraint among the first supply segment and the second supply segment.

13. The at least one machine-readable medium of claim 12, wherein the first supply segment includes nodes of the supply chain node hierarchy between the first demand node and the supply node not including the capacity node and the second supply segment includes nodes of the supply chain node hierarchy between the second demand node and the supply node not including the capacity node.

14. The at least one machine-readable medium of claim 9, wherein the capacity node is one of a transportation capacity node and a storage capacity node.

15. The at least one machine-readable medium of claim 9, further comprising instructions that, when executed by the at least one processor, cause the at least one processor to perform operations to:
determine that the supply node does not include a supply of the resource; and
discard the first resource supply capacity reservation.

16. The at least one machine-readable medium of claim 9, further comprising instructions that, when executed by the at least one processor, cause the at least one processor to perform operations to:
determine that the demand request has been fulfilled; and
discard the first resource supply capacity reservation.

17. A method for a constrained concurrent resource allocator, the method comprising:
receiving a first demand request including a first demand value for a first resource in a supply chain node hierarchy from a first demand node of the supply chain node hierarchy;
traversing the supply chain node hierarchy to identify a capacity node of the supply chain node hierarchy between the first demand node and a supply node of the supply chain node hierarchy, wherein the supply node includes an indication of a supply of the first resource;
creating a first resource temporary capacity reservation at the capacity node;
identifying an available supply of the first resource in the supply chain node hierarchy; and
replacing the first resource temporary capacity reservation with a first resource supply capacity reservation equal to a supply of the first resource processed by the capacity node using the available supply.

18. The method of claim 17, further comprising:
receiving a second demand request including a second demand value for a second resource from a second demand node;
identifying that there is insufficient capacity at the capacity node for the second resource based on the first resource temporary capacity reservation;
repolling the capacity node upon expiration of a timeout value to determine the current capacity of the capacity node;
creating a second resource temporary capacity reservation at the capacity node;
identifying an available supply of the second resource at the supply node; and
replacing the second resource temporary capacity reservation with a second resource supply capacity reservation equal to a supply of the second resource processed by the capacity node using the available supply of the second resource.

19. The method of claim 18, wherein the first demand request is received from a first supply segment and the second demand request is received from a second supply segment.

20. The method of claim 19, wherein the capacity node represents a shared constraint among the first supply segment and the second supply segment.

21. The method of claim 20, wherein the first supply segment includes nodes of the supply chain node hierarchy between the first demand node and the supply node not including the capacity node and the second supply segment includes nodes of the supply chain node hierarchy between the second demand node and the supply node not including the capacity node.

22. The method of claim 17, wherein the capacity node is one of a transportation capacity node and a storage capacity node.

23. The method of claim 17, further comprising:
determining that the supply node does not include a supply of the resource; and
discarding the first resource supply capacity reservation.

24. The method of claim 17, further comprising:
determining that the demand request has been fulfilled; and
discarding the first resource supply capacity reservation.
